(19) United States
(12) Patent Application Publication
(10) Pub. No.: US 2002/0163193 A1
(43) Pub. Date: Nov. 7, 2002

(54) Pipe coupling

(76) Inventor: Adel A. Abuellel, Albertville, AL (US)

Correspondence Address: MANELLI DENISON & SELTER, 2000 M STREET NW SUITE 700, WASHINGTON, DC, 20036-3307, US

(21) Appl. No.: 10/107,152

(22) Filed: Mar. 28, 2002

Related U.S. Application Data
(60) Provisional application No. 60/279,772, filed on Mar. 30, 2001.

(51) Int. Cl. F16L 21/02

(52) U.S. Cl. 285/337; 285/374

(57) ABSTRACT

A pipe coupling has an enlarged end for receiving a pipe end and a flange apertured for supporting coupling bolts; a tightening ring is placed around the pipe end and includes a slanted radially inner surface cooperating with a gripping ring; a slide ring is placed about the pipe end to be engaged by an end of the gripper ring; the enlarged end has a seal cavity with an inner slanted surface for engaging a seal ring; the gripper ring has two pairs of teeth extending radially inwardly to different extents with the axially inner pair being of greater length than the outer pair.

### FIELD OF THE INVENTION

This invention relates to pipe couplings where the pipe is made from plastic such as polyolefin, polyvinyl chloride or ductile iron or similar materials that are at least slightly deformable under localized pressure. In particular, this invention relates to an improved gripper ring for use in couplings where a sealing ring is compressed by a portion of a ring member when the coupling is installed. Specifically, the gripper ring is provided with a plurality of annular teeth which extend radially inwardly to different distances relative to the axis of the coupling and pipe end being coupled.

### BACKGROUND OF THE INVENTION

In many fluid handling systems, couplings for pipe ends are employed in constructing the system and the prior art has proposed a variety of different coupling structures to enable users to install the systems with secure couplings or joints between pipe ends. In some of these designs, a portion of the flow path is obstructed by the coupling mechanism and this is undesirable as the obstruction causes premature wear on the pipe particularly where the fluid being carried includes solid materials. In other arrangements, the labor required to establish the coupling is excessive due to the number of parts that must be used to assure a leak proof connection. In still other systems, where the couplings are located, for example, under vehicle thoroughfares, the stability of the coupling is adversely affected by heavy traffic leading eventually to leakage or failure of the coupling.

In view of these difficulties, there is a need for a secure, leak free pipe coupling that can be easily and quickly installed, has few parts and provides a clear flow path through the coupling.

### SUMMARY OF THE INVENTION

The coupling of the present invention, in one form, includes a sleeve having enlarged ends for receiving a pipe end. The sleeve includes two or more apertured flanges at each end for receiving a tightening bolt. The interior of the sleeve may include a seat for the end of the pipe and a wall portion that is slanted relative to the axis of the sleeve to serve as a seat for a seal member. The sealing elements of the coupling include a slide ring, a gripper ring and a locking ring. The locking ring includes apertures for receiving the tightening bolts and has a radially inner surface that is slanted axially and engages an outer slanted surface of the gripper ring. The slide ring and gripper ring each have mutually abutting ends with the opposite end of the slide ring engaging a flexible seal ring or annular gasket to compress the gasket into sealing engagement with adjacent surfaces of the coupling. The gripper ring has a plurality of radially inwardly extending annular edges or teeth members, the radial extent of which differ from adjacent edges or teeth members to improve the gripping action of the gripper ring when the tightening bolts are tightened to urge the gripper ring axially toward the slide ring and seal member.

With this structure, the action of the teeth will penetrate the surface of the pipe being coupled when moved by the tightening bolts to effectively lock the position of the slide ring against the seal member.

The foregoing and other advantages of the invention will become apparent as consideration is given to the following description and the accompanying drawings, in which:

### BRIEF DESCRIPTION OF THE DRAWINGS

FIG. 1 is section view of one end of a pipe coupling according to the present invention;

FIG. 2 is a detailed view in section of a portion of the gripper ring;

FIG. 3 is a detailed view in section of the gripper ring engaging the surface of a pipe end; and

FIG. 4 is a detailed view in section similar to FIG. 3 but showing a variation of the invention.

### DETAILED DESCRIPTION OF THE INVENTION

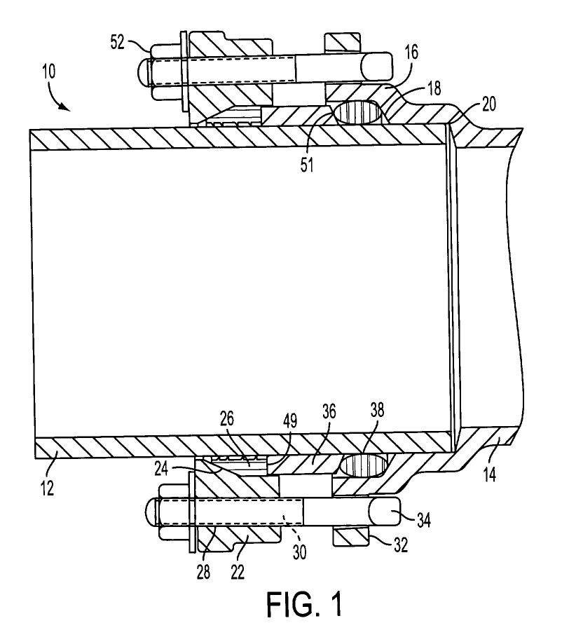

Referring to the drawings, wherein like numerals designate corresponding parts throughout the several views, in FIG. 1 there is shown a sectional view of a coupling 10 for two pipe ends one of which is shown at 12 inserted into a coupling sleeve 14. It will be understood that this view is symmetrical about the center of sleeve 14 and only the left end elements of the coupling 10 are illustrated, the opposite end being identical.

The coupling sleeve 14 is provided with an enlarged end 16 which includes a slanted interior wall 18 and the pipe end seat 20. Externally of the end 16 are provided two or more flanges 32 which are apertured to receive tightening bolts as described below. The coupling 10 further includes a tightening ring 22 which surrounds a gripper ring 26, one end of which abuts a slide ring 36 which, in turn, abuts for compression purposes a resilient seal ring 38, one side of which abuts the slanting wall 18 of the sleeve end 16.

The tightening ring 22 has two or more bores 28 for receiving tightening bolts 30 so that the bolts will each extend through a bore 28 and through the aperture in the flange 32. Preferably, the bolts have an anchoring portion or catch 34 to facilitate engagement between the tightening ring 22 and the flanges 32 of the sleeve 14. With this arrangement, tightening of the nuts 52 on the threaded ends of the bolts 30 secure the elements together and assure a fluid tight seal as described below.

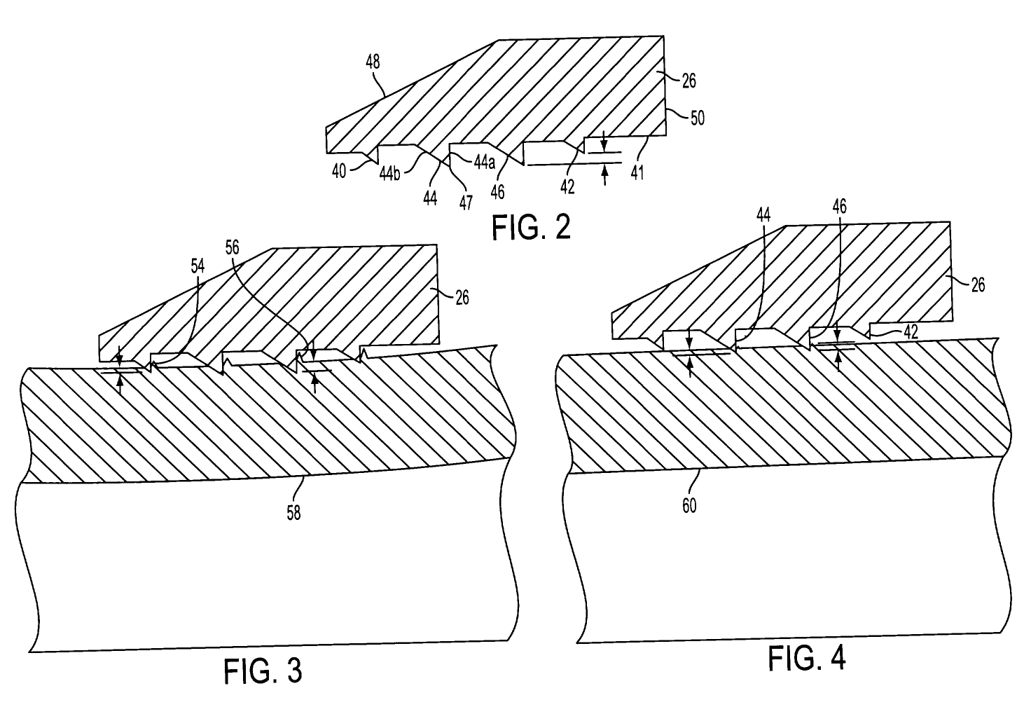

The radially interior surface 24 of the tightening ring 22 is slanted to cooperate with a complementary surface 48 on the gripper ring 26. The end of the gripper ring 26 opposite the slanted surface 48 is preferably flat or planar, as shown in FIGS. 2-4, to provide a stable engagement with the planar surface 49 of the slide ring 36. To improve the compression of the seal ring 38, the opposite side 51 of the slide ring 38 is slanted substantially to the same degree as the opposite wall 18 of the sleeve 14. The surface 51 and the wall 18 together define a cavity for the seal ring 38 with the wall 18 being movable toward the slide ring 36 when the nuts 52 are tightened on the end of bolts 30. Thus, once the resilient seal ring 38 is compressed between surface 51 and 18, the radial expansion of the seal ring 38 due to the orientation of the surfaces 51 and 18 will assure leak proof operation of the seal ring 38.

According to the present invention, the chance that the compressive force of the coupling on the seal ring 38 will be decreased is minimized by the construction of the gripper ring 26. Such a diminution of the force compressing the seal ring 38 may be due to vibrations imposed on the coupling where the pipe is buried under a roadway which is subjected to heavy traffic. Over time, such continued vibrations can result in wear on the connecting flanges 32 and the catch 34 or even in loosening of the threads of the nuts 52. Of course, other environmental conditions may also result in a tendency for the compressive force imposed by the tightened bolts 30 to decrease such as extreme temperature changes either externally or due to the temperature changes of the material being carried through the pipe 12. To counteract these effects, the present invention provides a unique set of annular gripping edges or teeth 40, 42, 44 and 46 on the radially inner surface 41 of the gripper ring 26. A shown in FIG. 2, each tooth is provided with a radially extending surface 44a and a slanted backup surface 44b which extends at an angle from the inner edge 47. Of primary importance is the different heights to which the teeth extend with the teeth adjacent the axially outer end of the gripper ring 26 as at 40 and 42 extending radially inwardly from the surface 41 of the body of the ring 26. As shown in FIGS. 2-4, the inner teeth 44 and 46 differ in height slightly from the axially outer teeth 40 and 42. Preferably, this difference in the radial extents will be on the order of 0.0200 in. However, this will have a major impact on the gripping force exerted by the ring 26 once it engages the surface of the pipe 12 being coupled as will be evident from FIGS. 3 and 4 to which reference is now made below.

With the coupling established as shown in FIG. 1, an operator will commence tightening and securing the coupling by tightening the nuts 52 on the bolts 30. Initially, this will result in sliding movement of the gripper ring 26 and the slide ring 36 over the surface of the pipe 12 to result in a compression of the O-ring 38. Continued tightening of the nuts 52 will, however, cause the force exerted by the surface 24 of the tightening ring 22 to be transmitted to the surface 48 of the gripper ring 26 and where the pipe is polyethylene or polyvinyl chloride material, the central teeth 44 and 46 will commence penetration of the surface of the pipe 58 as shown in FIG. 3. Continued tightening of the nuts 52 will cause the outer teeth sets 40 and 42 to also penetrate the surface of the pipe 58. Where the gripper ring 26 is made of the coated steel or ductile iron, and the pipe 58 is of a plastic material as described above, penetration on the order of about 0.04 inches for the central teeth 44 and 46 will be effected while the penetration of about 0.02 inches for the outer teeth 40 and 42 of the gripper ring will be effected.

Where the pipe 60 is a metal such as ductile iron, the penetration of the teeth 44 and 46 of the gripper ring will be substantially shallower then is the case with a plastic pipe 58. Typically, a penetration for the larger teeth 44 and 46 will be on the order of about 0.01 to 0.02 in. In most cases, the shorter teeth 40 and 42 will not penetrate the surface of the iron pipe 60. This should be acceptable in almost all applications as the ductile iron pipe will not exhibit the effects of the traffic induced vibrations to the same extent as the plastic pipe 58.

There are several advantages to use of a gripper ring 26 having at least two sets of teeth of different radial heights. Firstly, one type of the gripper ring need be manufactured to achieve secure gripping in either a plastic or a ductile iron pipe. Secondly, once the teeth of the gripper ring 26 are embedded in the surface of the pipe, substantially uniform compression of the resilient O-ring seal 38 will be assured over a wide range of conditions.

Having described the invention, it will be apparent to those skilled in this art that various modifications can be made to the invention with departing from the spirit and scope of the invention.

What is claimed is:

1. A pipe coupling for a pipe having cylindrical end without a flange and which is made of one of plastic or ductile iron, the coupling comprising a coupling sleeve having an enlarged end for receiving the end of the pipe and an interior surface for defining a seal cavity between the surface of the pipe end and said interior surface of said enlarged end of said coupling sleeve, a tightening ring having a slanted radially interior surface portion and positionable over the pipe end and being relatively movable with respect to the pipe end, a slide ring and a gripper ring, said gripper ring having a radially inner surface provided with a plurality of gripping members extending radially inwardly, said gripper ring having a slanted radially outer surface for engaging the slanted interior surface portion of said tightening ring, said slide ring having an end for engaging a seal ring placed around the pipe end and an opposite end for engaging said gripper ring so that when said tightening ring is moved toward said enlarged end of said coupling sleeve, said gripper ring will be moved by said tightening ring to move said slide ring against said seal ring to compress said seal ring in said seal cavity and against the surface of the pipe end and to move at least some of said gripping members into the surface of the pipe.

2. The invention as claimed in claim 1 wherein said tightening ring includes a plurality of bolt holes and said enlarged end of said coupling sleeve includes a flange having openings for receiving bolts connecting said tightening ring to said enlarged end of said coupling sleeve.

3. The invention as claimed in claim 1 wherein said end of said slide ring for engaging said seal ring is slanted and said seal cavity of said enlarged end of said coupling sleeve has an interior surface slanted to complement the slant of said end of said slide ring.

4. The invention as claimed in claim 1 wherein said gripping members of said gripping ring are provided in at least two sets each having different radial extents.

5. The invention as claimed in claim 4, wherein the gripping members of one set are located axially outwardly of the gripping members of the other of said sets.

6. The invention as claimed in claim 4, wherein said gripping members each have a radially extending surface on one side and a slanted backup surface on the opposite side with said radially extending surface and backup surface meeting to define an edge for each gripping member.

7. The invention as claimed in claim 5 wherein the gripping members of the one set located axially outwardly are shorter in radial extent than the radial extent of the gripping members of the other set.
